(19) United States
(12) Patent Application Publication
(10) Pub. No.: US 2023/0142896 A1
(43) Pub. Date: May 11, 2023

(54) BOILING ASSISTED CHANNEL TEMPLATING FOR ADSORBENT COATING FABRICATION

(71) Applicant: MASSACHUSETTS INSTITUTE OF TECHNOLOGY, Cambridge, MA (US)

(72) Inventors: Evelyn Wang, Cambridge, MA (US); Cody Jacobucci, Pilesgrove, NJ (US); Xiangyu LI, Somerville, MA (US); Bachir EL FIL, Cambridge, MA (US)

(73) Assignee: MASSACHUSETTS INSTITUTE OF TECHNOLOGY, Cambridge, MA (US)

(21) Appl. No.: 17/982,727

(22) Filed: Nov. 8, 2022

Related U.S. Application Data
(60) Provisional application No. 63/276,912, filed on Nov. 8, 2021.

(51) Int. Cl. B01J 20/32; B01J 20/28; B01J 20/30

(52) U.S. Cl. CPC B01J 20/3236; B01J 20/3238; B01J 20/28085; B01J 20/3078

(57) ABSTRACT

A simplified method of making an adsorbent layer can permit design and analysis of sorption systems having improved performance can include generation of one dimensional channels.

### CLAIM OF PRIORITY

This application claims priority to U.S. Provisional Patent Application No. 63/276,912, filed Nov. 8, 2021, which is incorporated by reference in its entirety.

### GOVERNMENT SPONSORSHIP STATEMENT

This invention was made with Government support under Grant No. HR0011-21-2-0001 awarded by the Defense Advanced Research Projects Agency (DARPA). The Government has certain rights in the invention.

### FIELD OF THE INVENTION

The invention relates to methods of making an adsorbent layer and devices including the adsorbent layer.

### BACKGROUND

Adsorption systems need to balance many factors to be successful for a given objective, weighing the kinetics of a given process against the device mass and volume for a variety of operational conditions. Adsorption systems have a wide range of applications that sit at the forefront of challenges presented by climate change, spanning direct air carbon capture, to atmospheric water harvesting, to thermal energy storage, to heating, ventilation, and air conditioning (HVAC) applications.

### SUMMARY

In general, a simplified method of making an adsorbent layer can permit design and analysis of sorption systems having improved performance.

In one aspect, a method of fabricating an adsorption layer on a surface can include infiltrating a mixture of an adsorbent material and a liquid into a porous structure, and heating the liquid at a pressure and temperature to create bubbles at a surface of the porous structure, thereby evaporating the liquid to form a coating layer of adsorbent material on the surface of the porous structure. The method can produce a porous structure that includes a majority of vapor channels continuous through a thickness of the porous structure.

In another aspect, a sorption bed can include a porous structure including a coating layer of adsorbent material on the surface of the porous structure, wherein the porous structure includes a majority of vapor channels continuous through a thickness of the porous structure.

In certain circumstances, the coating layer can include one-dimensional channels normal to a source of the heating.

In certain circumstances, the pressure can be atmospheric pressure.

In certain circumstances, the liquid can be water and the temperature can be greater than 60° C. and less than 150° C. In preferred embodiments, the temperature can be between 100° C. and 140° C. For example, the temperature can be about 120° C. The pressure can be atmospheric pressure.

In certain circumstances, the heating can be maintained for 60 minutes or less. For example, the heating can be maintained for less than 30 minutes, less than 20 minutes, less than 15 minutes, or less than 10 minutes.

In certain circumstances, the adsorbent material can include a zeolite, biporous zeolite, activated carbon, metal organic framework, silica gel, hygroscopic salt, hydrophilic polymer or any combinations thereof. For example, the adsorbent material can include a zeolite.

In certain circumstances, the porous structure can include metallic or carbon-based foam. For example, the porous structure can include a copper foam.

In certain circumstances, the porous structure can include a majority of vapor channels continuous through a thickness of the porous structure.

In certain circumstances, the adsorbent material on the surface of the porous structure can be on a surface of the vapor channels.

In certain circumstances, the porous structure can have an average pore diameter of between 50 and 250 microns. In other circumstances, the porous structure can have an average pore diameter of between 0.4 and 2.5 mm.

In another aspect, an adsorption driven cooling system can including a sorption bed as described herein.

In another aspect, a capture device can include a sorption bed as described herein.

Other aspects, embodiments, and features will be apparent from the following description, the drawings, and the claims.

### BRIEF DESCRIPTION OF DRAWINGS

FIG. 1 depicts a sorption coating.

FIGS. 2A-2B show images. FIG. 2A depicts an SEM image of the immersion dried sample. FIG. 2A depicts a zoomed in SEM image of a single pore of the same sample shown in FIG. 2A.

FIGS. 3A-3B show images. FIG. 3A shows a BACT sample using 150° C., with clear coalesced vapor pockets resulting in large sections of sparsely coated copper foam and clogged pores elsewhere. FIG. 3B shows a magnified view of sample revealing limited adsorbent crystals coating the foam in the coalesced vapor pocket.

FIG. 4 shows different adsorbent coating structures as a function of temperature used for BACT coatings, where the blue circles represent adsorbent crystal alignment. Low temperatures result in a random porous media, and high temperatures result in large vapor pockets that escape through sides rather than the top of the coating, as well as scaffolding that forms at the bottom. The solid bar represents the hot plate.

FIGS. 5A-5B depict images. FIG. 5A shows an SEM image of BACT sample. FIG. 5B shows a magnified SEM image of a single pore of the same sample in FIG. 5A.

FIG. 6 shows a schematic of experimental setup to test the performance of fabricated adsorbent samples.

FIG. 7A shows heat flux and change in temperature of the fluid over the course of the 200 second experiment. FIG. 7B shows pressure measured during the experiment using the Baratron pressure transducer. This was a 1 mm sample tested at 38° C. with a porosity of 0.6.

FIG. 8 shows uptake curve as a function of time for three experimental runs with 1 mm sample at 38° C. and 0.6 porosity. The error bars are shown for the run average, and the green line represents the reference model.

FIG. 9 shows average Power and SCP of sample as a function of time. Shorter adsorption periods result in higher performance metrics. In black is a reference point from recent work from Sapienza et al. as a literature leading benchmark for Z02 at these conditions. See reference below to V. Palomba et al.

FIG. 10 shows uptake for optimized BACT sample compared against the straight channel limit model for a 2 mm sample at 38° C., 0.68 porosity. Also shown is a 2 mm ID sample tested at 38° C., 0.63 porosity compared against the random porous model.

FIG. 11A shows a ratio of the mass transfer convective resistance of water vapor to the mass transfer conductive resistance for a coating height of 1 mm A Biₘ<0.1 indicates that the pore can be modeled as having a constant concentration through the height of the pore. FIG. 11B shows a resistance ratio for a 2 mm coating height.

FIG. 12A shows characteristic time to adsorb

$$( 1 - \frac{1}{e} ) Δ w$$

for traditional ID and BACT samples. FIG. 12B shows collected water in kg/m² of device as a function of adsorbent thickness for ID and BACT samples.

FIG. 13 shows adsorption and desorption cycle with 1 mm sample at 38° C. with a porosity of 0.6. This is measurement of the heat flux measured during the experiment. The initial curve is first curve after sitting in vacuum for 30 min, and the second and third peaks represent steady state. Dashed black lines are shown as a reference to highlight the repeatability of each cycle.

FIG. 14A shows boundary conditions for the straight channel pore model. FIG. 14B shows the uptake at 75 seconds for a 1 mm tall, 20 micrometer adsorbent coating shows a very small spatial dependence due to the small length scale of the coating.

FIGS. 15A-15C show a schematic of the BACT coating method. FIG. 15A depicts a schematic of a porous medium of thickness, δ, filled with adsorbent-water mixture exposed a heated surface with a heat flux, q^{∧}″ at t=0 s. FIG. 15B depicts a schematic of BACT method at t=Δt (during the process) shows the start of vapor generation at designated bubble nucleation sites. FIG. 15C depicts a schematic of BACT that shows, as time goes by, the vapor expands and starts filling in the voids of the porous medium until it reaches the surface, creating the one-dimensional vapor channels.

FIG. 16 shows an SEM image of adsorbent coated on a copper foam.

FIG. 17 shows a graph depicting a variation of the adsorption time constant as function of the copper foam thickness comparing the BACT method kinetics to those of the ID method.

### DETAILED DESCRIPTION

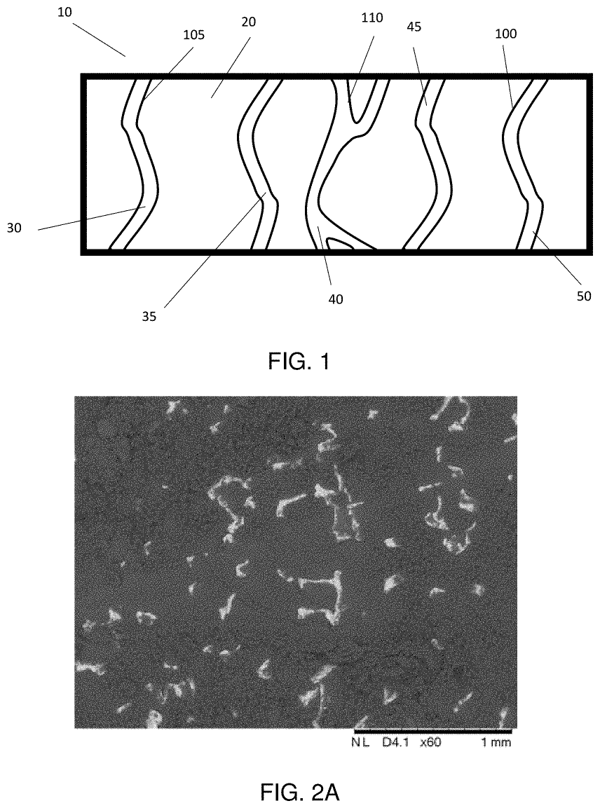

A sorption bed can include a porous structure including a coating layer of adsorbent material on the surface of the porous structure, wherein the porous structure includes a majority of vapor channels continuous through a thickness of the porous structure. Referring to FIG. 1, sorption bed 10 includes a porous structure 20. The surface of porous structure 20 is a network of pores. The pores of the network of pores can extend from one face of the porous structure 20 to an opposite face of the porous structure 20. For example, pores 30, 35, 40, 45 and 50 can extend through the porous structure 20, allowing a gas or liquid to pass through the porous structure. For example, a gas can flow through the pores of the porous structure to contact all surfaces of the porous structure with little interference or resistance to the flow. The surface of the porous structure can include a coating layer of adsorbent material, for example coating layers 100, 105 and 110. The coating layer of adsorbent material is thin relative to the thickness of porous structure 20, so the coating layers are not shown as distinct layers in FIG. 1. The coating layers of adsorbent material can be continuous or discontinuous. The porous structure includes a majority of vapor channels, such as pores coated by the adsorbent material, that are continuous through a thickness of the porous structure. The adsorbent material does not close or cover the pores.

In certain circumstances, the porous structure can have an average pore diameter of between 50 and 250 microns. In other circumstances, the porous structure can have an average pore diameter of between 0.4 and 2.5 mm. For example, the porous structure can have an average pore diameter of 50 microns, 60 microns, 70 microns, 80 microns, 90 microns, 100 microns, 110 microns, 120 microns, 130 microns, 140 microns, 150 microns, 160 microns, 170 microns, 180 microns, 190 microns, 200 microns, 210 microns, 220 microns, 230 microns, 240 microns, or 250 microns. The porous structure can have a thickness of 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, or 2.5 mm. When coated, the average pore diameter can be reduced by 20%, 30%, 40%, 50%, 60%, 70%, or 80%.

The structure described in general and depicted in FIG. 1 can be manufactured by a method of fabricating an adsorption layer on a surface can include infiltrating a mixture of an adsorbent material and a liquid into a porous structure, and heating the liquid at a pressure and temperature to create bubbles at a surface of the porous structure, thereby evaporating the liquid to form a coating layer of adsorbent material on the surface of the porous structure. In certain circumstances, the bubbles can initiate formation at a base of the surface, near an interface of a heat source that is causing the heating and a porous matrix. For example, the bubbles can form a slug or jet flow of adsorbent material to create a continuous channel. The continuous channel can be in the direction of a temperature gradient through a coating, away from the heat source. The method can produce a porous structure that includes a majority of vapor channels continuous through a thickness of the porous structure. The method is termed a boiling assisted channel templating (BACT) method because the channels are formed as a result of the boiling process during fabrication.

As a result of the process, the coating layer can include one-dimensional channels normal to a source of the heating. The channels can extend away from the source of heating. In part, this can be a result of the dynamics of boiling the liquid to remove the liquid from the structure. The dynamics of this process are described in more detail below.

The coating layer, which can be continuous or discontinuous, can be on a surface of vapor channels that can be a portion of the porous structure. The methods described herein can be used to deposit the coating layer on the surface of the vapor channels.

The mixture can include a liquid. The liquid can include an inorganic solvent or an organic solvent. The liquid can include water, an alcohol, or mixtures thereof. In certain circumstances, the pressure of the system during the heating step can be atmospheric pressure. If the process is carried out in elevated pressure or reduced pressure relative to atmospheric pressure. For example, the liquid can be water and the temperature can be greater than 60° C. and less than 150° C., or between 100° C. and 140° C. at atmospheric pressure. In certain circumstances, the temperature can be about 120° C. with water and at atmospheric pressure. In another example, a reduced pressure can be applied to facilitate boiling at a reduced temperature. The temperature can be selected based on viscosity of the mixture and boiling point of the mixture. The temperature should result in relatively rapid removal of the liquid to form the coating layer while maintaining with open channels though the porous structure.

In certain circumstances, the heating can be maintained for 60 minutes or less. For example, the heating can be maintained for less than 30 minutes, less than 20 minutes, less than 15 minutes, or less than 10 minutes. When the liquid is water, the pressure is at one atmosphere, and the adsorbant material is a zeolite, the heating can be maintained for as little as 5 minutes to produce the sorption bed.

The porous structure can be, for example, a metallic or carbon-based foam. In specific examples, the metallic or carbon-based foam can be a copper, aluminum, nickel, carbon fiber, and graphite foam). Without limitation, examples described below reference copper foam. Other foams are within the scope of the discoveries described herein.

The porous structure can have a porosity of greater than 75%, greater than 80%, greater than 85%, greater than 90%, or greater than 95%. The porous structure can have vapor channels through the material.

In certain circumstances, the adsorbent material can include a zeolite, biporous zeolite, activated carbon, metal organic framework (MOF), silica gel, hygroscopic salt, hydrophilic polymer or any combinations thereof. For example, the adsorbent material can include a zeolite.

As described below, an adsorption driven cooling system can including a sorption bed as described herein.

In other embodiments, a capture device can include a sorption bed as described herein. The capture device includes an adsorbent material and pore size selected for sequestering a target material. The target material can be water or a carbon-containing moiety. The capture device can include a water harvesting device or a carbon capture device.

A boiling assisted channel templating (BACT) method, as described herein, can result in sorption beds that exhibit enhanced adsorption cooling and water adsorption properties. By understanding the dominant diffusive resistances, the fabrication method described herein was developed to increase the performance of coatings by more than double the traditional immersion drying approach per unit mass of adsorbent. The characteristic inter-crystalline diffusive length scale decreased from 1 mm to 20-30 μm, reducing the characteristic inter-crystalline diffusion time scale by about 250. This result helped produce a record SCP_{m,ads} of 1875 W/kg for Z02 at these operating conditions, but can double the projected SCP_{m,tot} of the prototype currently under fabrication. This approach promises to bring adsorption based cooling significantly closer to deployment by cutting the required mass and volume of the ABU by a projected 50%. This would translate to a 1.5 kW system with a SCP_{m,tot} of 375 W/kg-2.5 times that of the work produced by Sapienza under comparable conditions. See, for example, M. Verde, L. Cortes, J. M. Corberán, A. Sapienza, S. Vasta, and G. Restuccia, “Modelling of an adsorption system driven by engine waste heat for truck cabin A/C. Performance estimation for a standard driving cycle,” Applied Thermal Engineering, vol. 30, no. 13. Elsevier Ltd, pp. 1511-1522, 2010, doi: 10.1016/j.applthermaleng.2010.04.005, which is incorporated by reference in its entirety. A scaling guideline that be used to ensure Biₘ<0.1 by varying the adsorbent layer thickness and macro-pore diameter ratio, as this will lead to optimal performance for adsorption devices focused on maximizing power output.

The boiling assisted channel templating (BACT) method can facilitate better vapor transport through the coatings to increase the potential cooling power via enhanced adsorption kinetics, reduce material waste, and decrease required fabrication time. For example, this approach resulted in a performance of a specific cooling power of 1875 W/kg Z02 for a 120 second cycle-a record high number for Z02 under these operating conditions. Preliminary analysis suggests it would enable a system level specific cooling power of 375 W/kg of the entire adsorbent bed, compared to a previously proposed design with a specific cooling power of 200 W/kg.

The thermodynamics of the adsorption driven cooling (ADC) cycle is discussed. These cycles can be fairly simple. An adsorption bed unit (ABU) that is entirely desorbed as fully charged is used, as this state has the most potential to adsorb water and thus drive the most cooling via evaporation. Conversely, a fully saturated ABU is discharged, as it has no remaining potential to adsorb and thus no cooling potential. Beginning with the charging portion of the cycle, a fully saturated ABU is the starting point. To charge it, the ABU is heated with fluid directed from the engine that comes in at 90° C. As the ABU heats up, the relative pressure in the adsorbent bed increases, and it becomes thermodynamically favorable for the adsorbed water to desorb, as indicated by the isotherm of the material. This process absorbs a significant amount of heat equal to the adsorption enthalpy h_{ad}(J/kg water desorbed) plus the sensible heat required to heat up the heat exchanger, and this thermal energy is supplied via the circulating engine coolant. The desorbed water then condenses on the evaporator-condenser unit (ECU) that has ambient temperature fluid running through it to remove the latent heat of the condensed water on its surface. Once this process is complete, the ABU is charged and ready to drive cooling. The circulating fluid is switched to the ambient line to keep it cool, now releasing h_{ad} as it adsorbs, requiring sufficient flow to maintain this temperature and the adsorption rate that is very temperature dependent. This water is supplied from the surface of the wicking evaporator surface, which in turn cools the cabin coolant. The relevant temperature conditions for the cycle are defined as follows: the temperature of the ABU during adsorption is the adsorption temperature Tₐ, and its temperature during desorption is T_{d}. The thermodynamic cycle begins with a discharged ABU that undergoes isosteric heating by convective heat transfer from the engine coolant, while the condensing unit increases the pressure of water vapor in the chamber to the pressure exerted at its operating temperature T_{cond}. Next, the material begins to desorb while the bed continues to be heated to overcome the enthalpy required to desorb water, until it is fully charged. Once desorption is complete, the ABU is cooled and then will start adsorbing as the evaporator supplies vapor at a pressure of pₑ. The ABU is continuously cooled to reject the enthalpy of adsorption until fully discharged, and the cycle repeats. In most configurations, the system consists of two identical ABUs that alternate between adsorbing and desorbing to supply continuous power.

The evaporator temperature at this evaporating surface, Tₑ, and the condenser temperature T_{cond} also have a significant impact on performance, as higher evaporator temperatures provide higher pressures of water vapor available to be adsorbed, but also reduces the temperature difference between the cabin coolant and the air it is trying to cool. High condenser temperatures, directly limited by the ambient temperature conditions, create high vapor pressures on the surface and reduce the amount of adsorbate that can be desorbed from the ABU before equilibrium is reached.

In literature, various operating temperatures are used, where Tₑ ranges from 5 to 20° C., Tₐ from 20-40° C., T_{d} from 60-110° C., and T_{cond} from 20-40° C. See, for example, K. H. Cho et al., “Rational design of a robust aluminum metal-organic framework for multi-purpose water-sorption-driven heat allocations,” Nat. Commun., vol. 11, no. 1, pp. 1-8, December 2020, doi: 10.1038/s41467-020-18968-7, which is incorporated by reference in its entirety. Given the exponential nature of the vapor pressure of water with increasing temperature, these conditions make a large difference in the performance of the device, and care should be taken when comparing device performance. From experience with industry, automotive cooling specifically requires testing of the air-conditioning system up to 43° C. See, for example, “JSA—JIS B 8627-3-Gas engine driven heat pump air conditioners-Part 3: Ducted gas engine driven heat pump air conditioners-Testing and rating for performance|Engineering360.” [Online]. Available: standards.globalspec.com/std/1316080/jis-b-8627-3 Accessed: 8 May 2021, which is incorporated by reference in its entirety. While there is only a 3° C. difference from the commonly used 40° C., it can often make the difference between a highly effective design and a poor design based upon the chosen adsorbent-adsorbate working pair.

Further, there are very few MOFs that have a significant working potential in the range of conditions used in the automotive industry. AQSOA Z02, a commercially available zeolite, is still the best material for this range as will be discussed later. As such, adsorption based cooling systems are predominately based on zeolites and silica gels to date, but efforts to make MOFs more practical offer hope for the performance benefits they offer at commercial scale in the future. See, for example, A. Karmakar, V. Prabakaran, D. Zhao, and K. J. Chua, “A review of metal-organic frameworks (MOFs) as energy-efficient desiccants for adsorption driven heat-transformation applications,” Appl. Energy, vol. 269, no. March, p. 115070, 2020, doi: 10.1016/j.apenergy.2020.115070, which is incorporated by reference in its entirety.

In order to validate the modeling approach before finalizing the design, samples were successfully fabricated and a testing procedure was developed to evaluate the performance of adsorbent fins. Often in literature, the performance of the material is only tested on its own, or mass-based measurements of adsorbent coatings that can be unreliable due to noise introduced by flow rate variations or creep of the attached tubing. These mass-based measurements require large masses to keep experimental uncertainty low and thus do not facilitate testing variations in the coating method or coating porosity. The uptake of the fabricated adsorbent fins can be characterized by measuring the heat flux generated during adsorption for various cycle times, adsorption temperatures, flow conditions, coating thicknesses, and fabrication techniques in the custom build adsorption bed simulator, enabling rapid iteration of coating methods and design variations. A novel method of adsorption fin fabrication was developed to maximize the mass transport of the device while achieving an identical packing factor to previous fabrication methods, while simultaneously reducing fabrication time from 24 hours to 5 minutes to enable a more scalable approach.

The adsorbent coating can be fabricated as follows. First, before cleaning the copper foam, a mixture of AQSOA Z02 and deionized (DI) water was created. The mass of Z02 was measured using a mass balance, (Scout SPX2202, OHAUS) with 0.02 g resolution. Through experimentation, a mass ratio of zeolite was found:DI water of 1:1 worked best for coatings as it was viscous enough to maintain a good dispersion of particles through the entire deposition process. Too much water created a runny mixture that often resulted in the Z02 separating during the drying process, leaving the top of the sample bare. Once the mixture has gently been stirred for 1 minute to break up any large agglomerations of particles, the mixture is then sonicated in a bath sonicator for 30 minutes. While sonication is occurring, the copper foam was prepared.

In order to make the adsorbent fins, highly porous (95% porous) copper foam as sourced in various thicknesses from Green Creation Electronic Technology in 200×300 mm sheets. The copper foam was cut using a laser-cut template to size for the experiments-18×18 mm, which corresponds to the size of the heat flux sensor used later in the experiments. Afterwards, the foam was rinsed with DI water, followed by an ethanol rinse to make the foam hydrophilic, followed by another DI rinse. The copper foam was then finally cleaned in 2 M HCl to remove any present oxidation prior to deposition. The foam was then rinsed again with DI water, and immediately dried using compressed air to reduce any oxidation before deposition. It was found that removing any excess water was essential for consistent coating fabrication, as any retained water diluted the zeolite-water mixture used later for deposition, leading to higher than desired porosity and occasionally oxidation during the air drying process Immediately after drying, the foam should enter the deposition process.

There were multiple deposition processes tested over the course of this work. The initial method followed the work of LaPotin and Kim, and will be referred to as immersion drying, and a new method of fabrication is introduce here that creates a dense coating within the copper foam while simultaneously seeding vapor channels to enhance kinetics compared to work of others.

See, for example, S. Narayanan et al., “Thermal battery for portable climate control,” Appl. Energy, vol. 149, pp. 104-116, July 2015, doi: 10.1016/j.apenergy.2015.03.101, and A. LaPotin et al., “Dual-Stage Atmospheric Water Harvesting Device for Scalable Solar-Driven Water Production,” Joule, vol. 5, no. 1, pp. 166-182, January 2021, doi: 10.1016/j.joule.2020.09.008, each of which is incorporated by reference in its entirety. In the first method, the cleaned copper foam is placed into a glass dish and Z02 is poured over top until the material is entirely covered. This sample will dry overnight in ambient conditions and takes anywhere from 12 to 24 hours depending on the environmental conditions and the thickness of the coating.

The boiling-assisted channel templating (BACT) allows for the creation of nearly 1D vapor channels that can be seen without a microscope on the samples, and further visual examination reveals that these vapor channels are ubiquitous throughout the coating. The first step of this deposition method is to dip the copper foam into the mixture for 1 minute to allow for full infiltration of the mixture into the pores. It is then placed on a hotplate at 120° C. for 5 minutes. During this process, boiling is visible and bubbles can be seen at the surface of the foam. Various temperatures and loading ratios were tested for this process to achieve a reliable porosity of 0.6 of the resulting adsorbent coating, with 120° C. giving the best results.

In order to measure the porosity of the sample, the samples were made sure to dry for at least 24 hours to reach equilibrium with the laboratory. By using a temperature and relative humidity sensor (RH820U, OMEGA) to measure the relative humidity and temperature of the environment that the sample is in equilibrium with, the mass of the adsorbent can be calculated along with the coating porosity utilizing the measured isotherm of the adsorbent.

Testing results of the fabricated adsorbent coating samples are described. Samples were created for 0.5, 1.0, 1.5, and 2.0 mm thick copper foam using both approaches.

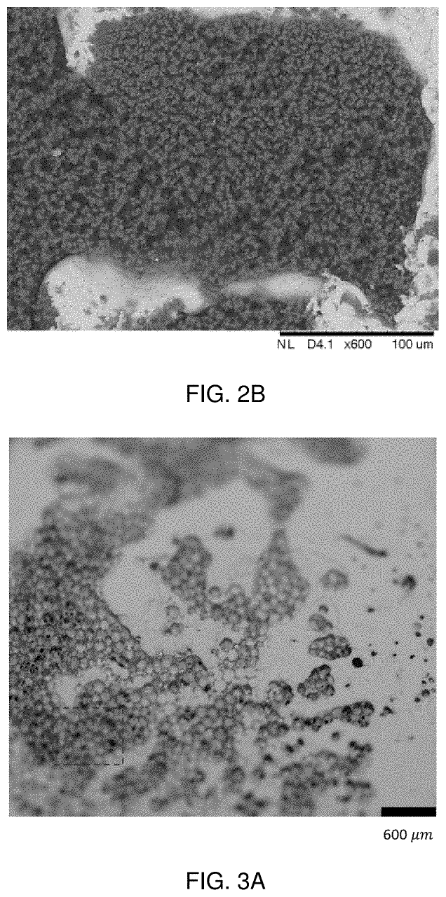

The immersion drying approach makes it very difficult to tailor the porosity, as the only adjustment that can be made is fine tuning the Z02-water ratio. A higher Z02 loading enables very dense coatings, with porosities as low as 0.4, making it ideal for applications that favor dense coatings, such as a thermal battery. This approach results in samples that resemble a random porous media very well, as is consistent with previous work. This approach, however, results in a significant amount of material waste-less than 50% yield of material due to the fact that the entire foam needs to be covered with extra Z02-water mixture to ensure a good coating. It also takes at least 24 hours before the coating is dry enough to remove for the 1.5 and 2 mm samples. In FIGS. 2A-2B, a SEM image of the immersion dried sample that shows a uniform coating over the copper foam is shown. In the zoomed in panel (FIG. 2B) is the coating filling a single pore. It should be noted that the pore is uniformly blocked, with clear sub 5 micrometer voids for vapor to transport through. This sample had a porosity of 0.6, which should have an average void size of approximately 2 μm based on the probabilistic model and seems to be the case when examining the SEM image.

The BACT process created to address the shortcomings of the immersion drying method in terms of material waste, long processing times, and poor adsorption rate limited by vapor transport rates due to its small resulting inter-crystalline pore sizes and naturally tortuous structure.

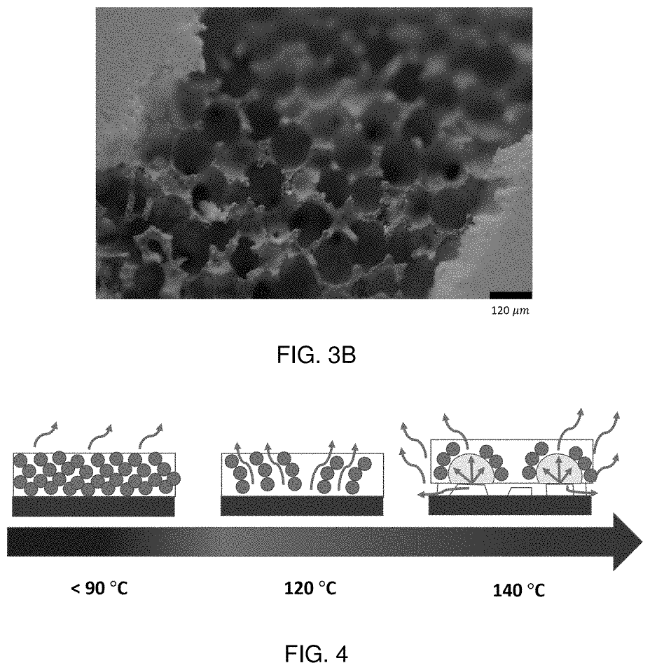

This fabrication method was tested between 80° C. to 170° C., which is well-below the >400° C. threshold where some zeolites begin to break down. See, for example, L. Z. Zhang, “Design and testing of an automobile waste heat adsorption cooling system,” Appl. Therm. Eng., vol. 20, no. 1, pp. 103-114, January 2000, doi: 10.1016/S1359-4311(99)00009-5, which is incorporated by reference in its entirety. A temperature of 120° C. was empirically found to be best for achieving the goal porosity of 0.6 consistently. It was also hot enough to create sufficient vapor pressure at the hotplate and copper interface for vapor channels to form, but not too high that the sample would vibrate on the plate. The generated vapor pressure compresses the adsorbent crystals in the mixture against the foam surface to create very dense coating layers on the foam. Even though there are large vapor channels, the component level porosity, which will be referred to as the macro-porosity, is still the same as the immersion drying method. Below 90° C., there is still an improvement in the coating performance, but the structure of the adsorbent crystals still resembles a loosely packed random porous media. High temperatures favor rapid release of vapor and often create vapor channels directed towards the sides rather than 1D channels normal to the hot plate to escape faster as vapor pockets coalesce at the base. The vapor generates enough pressure through the viscous mixture to lift the sample upwards, creating a scaffold of adsorbent crystals that is not structured around copper foam. This is less favorable as the scaffolded adsorbent will have limited heat transfer capability without the copper foam to facilitate heat conduction. These vapor pockets and scaffold can be seen in FIGS. 3A-3B. The coating is very sparse in these areas and is not the most efficient packing for optimal adsorption rate through the full device. FIG. 4 shows as a schematic of the result of operation temperature on pore structure. At temperatures below 90° C., the coating resembles a random porous media. As the temperature increases, visual boiling can be seen during the process and vapor channels are created. However, at high temperatures, adsorbent scaffold form at the bottom as the vapor pressure lifts the sample off the surface, creating sparse coatings and fewer 1D vapor channels as the vapor tries to escape through the bottom of the rapidly dried and porous structure.

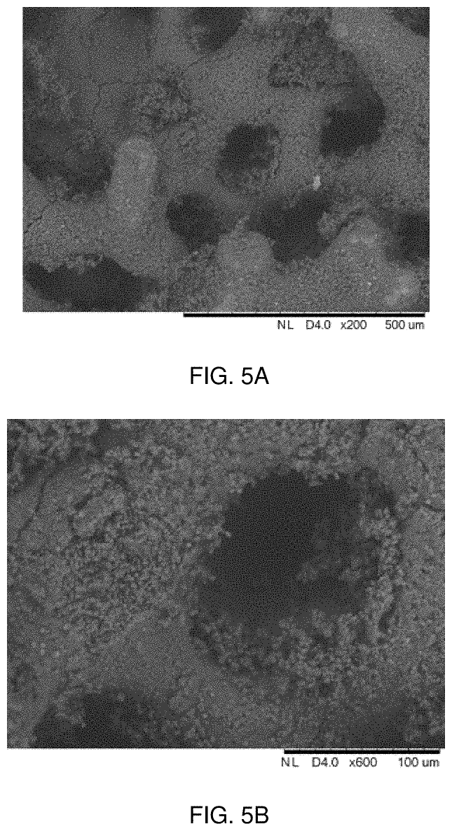

In FIGS. 5A-5B, the results of a BACT sample and the clear vapor channels that were created are shown. Optical microscopy confirmed that many of the vapor channels are continuous from top to bottom, or are connected to channels that span the thickness. This transforms the mass transfer of the coating significantly from one with reduced effective diffusivity coefficient for the tortuosity of a random porous media,

$${ε}^{\frac{3}{2}} ,$$

to a simple 1D diffusion problem in the radial direction limited by Knudsen diffusion of a much thinner random porous media. For these samples, that transforms the predominant characteristic length scale for water vapor transport from the foam thickness, on the order of millimeters, to the dense 10-30 μm coating surrounding the copper foam struts. In terms of order of magnitude analysis, while the pore size for diffusion through the adsorbent coating is smaller (10 times smaller than immersion dry samples for the same porosity) for BACT samples, the 100× reduction in the characteristic length scale for a 1 mm sample results in the reduction of the time scale for inter-crystalline diffusivity by 100, enabling rapid adsorption by via the high surface area for adsorption. To confirm this expected enhanced performance, experiments were conducted to characterize these samples along with the baseline samples used for the ABU.

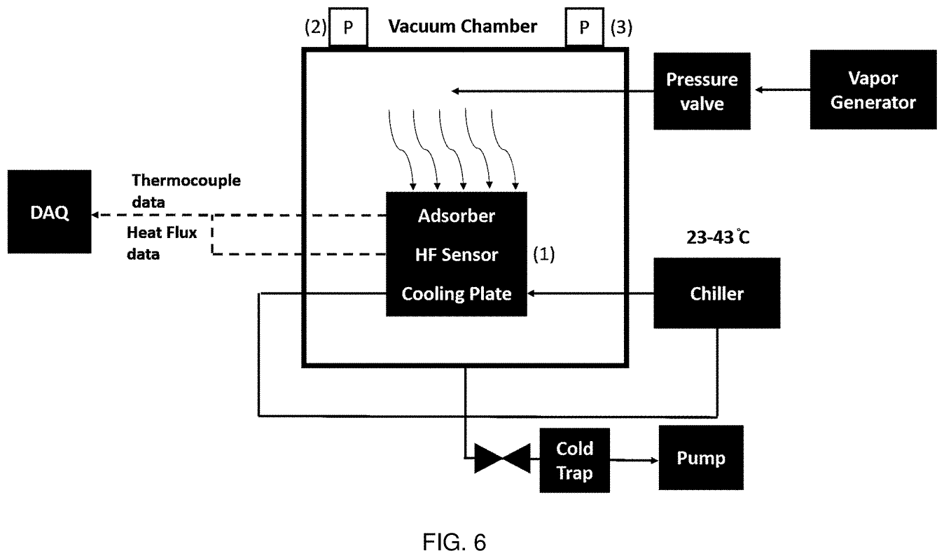

In order to compare the performance of the traditional ID coatings to the BACT coatings and validate the models used to design the ABU, the experimental setup in FIG. 6 was created. This experimental setup obtained the uptake of water by measuring the heat flux at the interface of a temperature-controlled surface and the adsorbent sample. With knowledge of the mass of the adsorbent in the sample and the adsorption enthalpy of the material, the adsorption rate was determined and was integrated to determine the uptake. By controlling the temperature of the coating and the operating relative pressure, it was possible to test the adsorbent samples at the various conditions that one would expect the ABU to experience in field use.

Experiments were conducted in a custom-built Kurt J. Lesker Vacuum chamber. The chamber was connected to a vacuum pump (Pascal 2010 SD, Adixen) that passes through a liquid nitrogen trap to pump down the chamber and remove any non-condensable gases and protect the pump from water vapor. There was a connection to a custom built water vapor generator consisting of a stainless steel, sealed chamber filled with DI water. This water vapor line was opened and closed with a regulated needle valve that allows for fine control of the flow of vapor to control the vapor pressure inside of the testing chamber accurately. In order to reject the entropy of adsorption as the sample adsorbs to maintain a target adsorption temperature, a fluid line was connected to the chamber that was cooled by a circulating chiller (Isotemp II, Fischer Scientific). The chamber was also surrounded with resistive heaters to regulate the chamber temperature to limit radiative losses. The heat flux was measured at the adsorber-cold plate interface using a calibrated heat flux sensor (1: XI 26 9C, gSkin). Fluid inlet and outlet temperatures, sample temperature, and the chamber temperature were measured using J-type thermocouples. The pressure of the chamber at low pressures (<10 Pa) was measured using a pressure transducer (2: 925 MicoPirani, MKS), while the pressure during experiments was measured using a pressure transducer more accurately at low to medium pressures (3: Baratron 722B12TGA2FJ, MKS).

The experimental procedure to test the adsorber began with pumping down the chamber to <1 Pa and allowing the sample to desorb for 24 hours. After this period, the chiller was started and the operating temperature was set. The chamber was pumped down again for another hour to ensure the removal of any desorbed gases before beginning experiments. Once a thermal steady state was achieved and the calibrated heat flux measurement was steady, the material was determined to be fully desorbed and experiments began. Once the custom LabView program began recording, the needle valve was opened to allow water vapor to enter the chamber. The pressure was monitored and the valve was adjusted to maintain the target vapor pressure. In this case, it was kept constant to replicate a 5.5° C. evaporator temperature. The pressure was maintained for the target adsorption time, and then the valve was closed to start desorption. The chamber is then evacuated for 30 minutes, and repeated again two more times so that each operating condition is tested three times for the sample. In addition to adsorption performance, the procedure was adapted to show the cyclical ability of the sample through multiple adsorption-desorption cycles by alternating between exposure to water vapor and evacuating the chamber using the vacuum pump. While it was not necessarily representative of the desorption process that was used in the target device (temperature swing desorption rather than pressure swing desorption), the focus of these experiments was to show the repeatability and relative performance of the samples against the model that was created to reflect these conditions and temperature swing experiments were not possible due to shortages in circulating baths. These experiments were run from 23-43° C. for samples ranging from 0.5 mm to 2 mm using both fabrication methods.

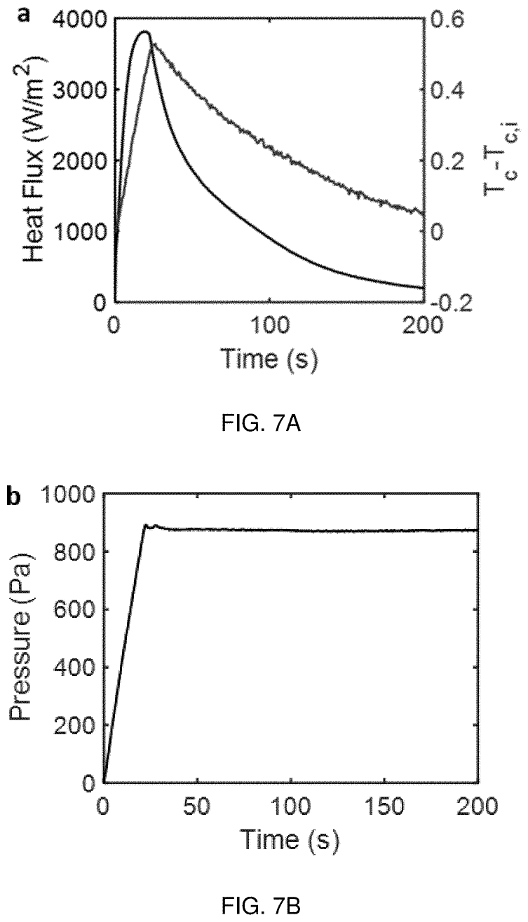

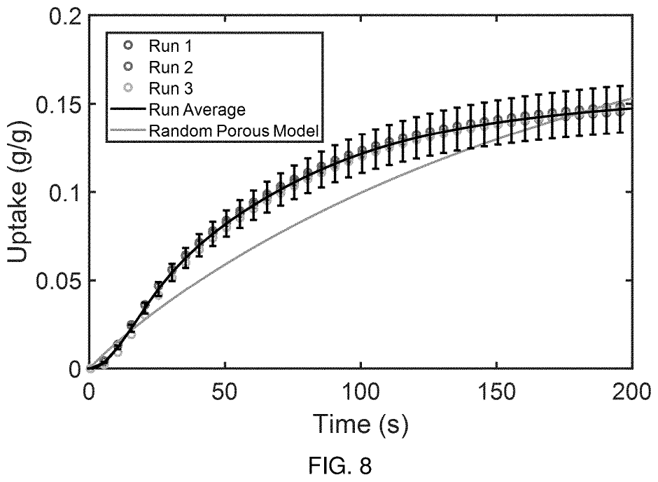

Adsorption experimental results are described. FIGS. 7A-7B show the results of a single run of a 1 mm sample with a macro-porosity of 0.6 and an adsorption temperature of 38° C. This sample was one of the first samples made with the BACT method at 90° C. The temperature of the coolant did not change by more than 0.5° C. during the peak of adsorption, which is in good agreement with the model. It was shown here that after an initial period that it takes for the chamber to fill with water vapor, the pressure remained constant at the desired pressure to simulate a 5.5° C. evaporator water surface. FIG. 8 is the result of three experiments with the same sample under the same conditions, showing good repeatability between runs. The average of the results is shown with error bars to represent the uncertainty of the measurements, which is dominated by resolution limitations of the scale to determine the uptake on a g/g basis based on the calculated sample macro-porosity. Also shown is the reference COMSOL model that was used. The results are in good agreement with the model at the end of the cycle, but it is clear that this sample was adsorbing faster than a random porous media model would predict, as is the current standard in literature. These results encouraged the work done to optimize the fabrication temperature used for the BACT method.

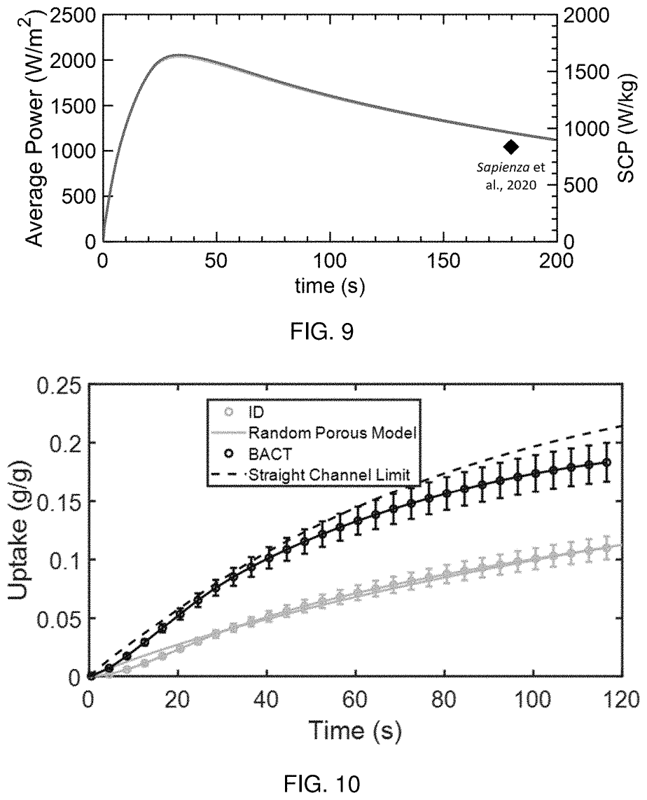

The resulting cooling powers calculated from these uptake rates was higher than leading literature values. In the recent work of Sapienza et al., the team produced an adsorption device with in situ. SAPO-34 coated al fins with an SCP_{ads} of 1100 W/kg for a half cycle, which translates to 550 W/kg at the full cycle of 700 seconds. See, for example, V. Palomba et al., “Evaluation of in-situ coated porous structures for hybrid heat pumps,” Energy, vol. 209, 2020, doi: 10.1016/j.energy.2020.118313, which is incorporated by reference in its entirety. The most direct comparison point comes at 177 seconds, shown in FIG. 9 as a black diamond with a reported SCP_{ads} of 805 W/kg, whereas the device has an SCP_{ads} of 950 W/kg at that point. With such thin coatings, the thermal time scales become more important and their material choice of aluminum fins at a length of 20 mm likely led to the reduced performance. Further, their approach has an adsorbent material to heat exchanger mass ratio of 0.15, which was far lower than if the BACT coating method was applied to the prototype device (ratio of 0.35) to achieve better performance. Δt this design point, the device performed 20% better than this literature leading value from an SCP_{ads} standpoint, but more importantly, promises to be better at the system level with double the ratio of adsorbent to heat exchanger mass.

Theoretically, BACT samples would be less limited by sample thickness and thus could have better specific cooling power with respect to mass and volume than thinner samples given their higher packing factor. The results of a sample made with the BACT method for a 120 second cycle time are shown in FIG. 10. Not only does the BACT sample significantly outperform the ID sample, but it even approached the practical limit of a straight walled channel. The details of the straight walled channel model can serve as a practical limit of what could be manufactured given current micro-machining technology and standard nanofabrication techniques. A straight walled channel with a structural pore size of 120 μm and a coating thickness of 20 μm at 0.3 porosity (this will be called the micro-porosity to reflect the local porosity of the adsorbent coating on the copper foam) was used to reflect findings in the SEM images and validated with first order calculations given the macro-porosity of the sample. Straight walled channels of this size would see limited diffusive resistance through the thickness of the foam and were modeled with the ideal case of a constant concentration boundary condition along the pore walls. The performance enhancement can be explained by increasing the surface area of adsorbent exposed to the boundary concentration due to the negligible mass transfer resistance through an 80 μm channel under vacuum conditions. In terms of order of magnitude analysis, the amount of adsorbent exposed to water vapor in the random porous model scales with the rectangular footprint of the coating. For the unit cell, this only has the surface area of a 120×120 μm rectangle. Adsorbent below this surface only adsorbs water vapor once the material above it approaches saturation, which is a very slow process that increases in length as the coating thickness grows. The straight wall channel, however, has this rectangular footprint surface area in addition to the surface area of a cylinder with 80 μm diameter and a height of 2 mm. This increases the surface area by approximately 35 times. Given that this process is inter-crystalline limited, increasing the surface area of exposed adsorbent is the most effective way to increase the kinetics of the process and thus create higher cooling powers.

The experiments were able to follow this limit closely until the end of the cycle. One can attribute this deviation from the limit due to non-uniform coating, especially near the adsorbent coating closer to the side that was at the top during fabrication, as more of the material tended to collect at this side due to the vapor pressure transporting the mixture upwards. While there will be significant surface area for uptake immediately during the adsorption process, these thicker coatings would decrease the adsorption rate as time goes on, as can be seen in FIG. 10. It is also expected that there exists some level of tortuosity in the sample still, and removing the tortuosity entirely from the governing equation through the coating thickness would be desired but not yet achieved.

To validate this assumption about the constant boundary concentration used in the model, one case can compare the internal mass transfer resistance of the water vapor moving through the channel, to the external mass transfer resistance of the vapor being adsorbed by the adsorbent coating the surface of the channel to gain insight into the limiting resistances. With these resistances defined as

$${R}_{int , m} = \frac{{t}_{a d s}}{\frac{{D}_{k} π {d}_{m p}^{2}}{4}}$$

$$and$$

$${R}_{e x t , m} = \frac{1}{\frac{15 {D}_{μ}}{{r}_{c}^{2}} * π {d}_{m p * {t}_{ads}}} ,$$

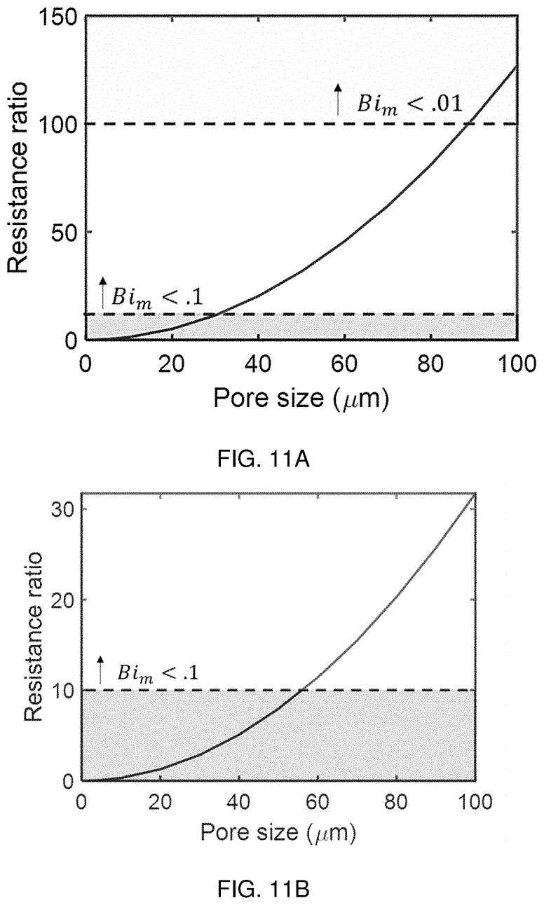

one can compare their ratios as a function of the vapor templated pore size dₘₚ and adsorbent coating thickness t_{ads}. In FIGS. 11A-11B, it can be seen that compared to previous approaches that only have pore sizes on the order of a single micrometers, one can see that

$$\frac{{R}_{e xt , m}}{{R}_{int , m}} ≫ 1$$

for a 1 mm sample height after a macro-pore size of 30 μm and 56 μm for a 2 mm thick sample. The fabrication method was able to create pores much larger at 80 μm. If the mass transfer Biot number Biₘ, where

$$B {i}_{m} = \frac{{R}_{int , m}}{{R}_{e xt , m}}$$

is compared, one can see that for a 2 mm sample, such as the ones fabricated in these samples, Biₘ, <0.1. This implies that a constant concentration through the pore channel is a valid assumption with <0.05% error as the resistance for water vapor transport through the pore is significantly less than the resistance to be adsorbed. For a Biₘ<0.01, one can be very confident in the results and a simple 1D model for diffusion of the vapor through the thin adsorbent coating on the copper foam should have less than a 1% error.

The 2 mm sample shows a SCP_{m,ads} of 1875 W/kg, an SCP_{m,ads+foam} of 1060 W/kg, and a SCP_{v,ads} of 2.85e3 kW/m³. Compared to the work of Sapienza et al., where Z02 was deposited into foam and on fins directly, a Tₑ of 20° C. Tₐ of 30° C., and a T_{d} of 90° C. As discussed previously, the thin tube coatings are not a fair comparison when considered on a volume basis, as very thin coatings always perform well. Compared to coating aluminum foam in the same work, which had an SCP_{ads}=300 W/kg and a SCPₜₒₜ of approximately 60 W/kg, if the same adsorbent mass to HX mass ratio is assumed from the prototype of 0.35 and a cyclical knockdown of 20% (see, for example, Y. I. Aristov, I. S. Glaznev, and I. S. Girnik, “Optimization of adsorption dynamics in adsorptive chillers: Loose grains configuration,” Energy, vol. 46, no. 1, pp. 484-492, October 2012, doi: 10.1016/j.energy.2012.08.001 and S. Graf, F. Lanzerath, A. Sapienza, A. Frazzica, A. Freni, and A. Bardow, “Prediction of SCP and COP for adsorption heat pumps and chillers by combining the large-temperature-jump method and dynamic modeling,” Appl. Therm. Eng., vol. 98, pp. 900-909, April 2016, doi: 10.1016/j.applthermaleng.2015.12.002, each of which is incorporated by reference in its entirety), one would be able to have an SCPₜₒₜ=375 W/kg. These results are ˜1.5× more mass efficient than the prototype SCPₜₒₜ, meaning it could cut the mass and volume of the adsorber in half. The design can be used in a next generation adsorption cooling system. While this approach holds promise for adsorption cooling, it also has significant opportunity to improve the performance of atmospheric water harvesting, as will be discussed below.

By tailoring the macro-pore size for hierarchical vapor transport through the adsorbent layer, the ratio of mass transfer resistances can shift to the point that Biₘ<0.1, indicating that the entire coating of the vapor channel (80 μm in this work) is exposed to the boundary concentration of water vapor. This is a significant improvement over previous work that typically had pore sizes less than a micrometer going through the entire thickness of the adsorbent layer. This effectively increases the surface area of adsorbent coating by 35 times and drastically improves the power generating capabilities of the adsorbent by reducing the required saturation time. For devices that are focused on power generation, the pore size should be tailored such that Biₘ<0.1, compared to previous designs that operate on the order of Biₘ>>1, which is more suited towards thermal energy storage as the objective is to maximize energy density and not necessarily power density. TES systems that may be more focused on storing as much energy as possible for future use. Power density critical applications require rapid cycling, favoring designs that have the fastest kinetics. In fact, setting Biₘ=0.1, one can determine the optimal scaling for the pore size and coating thickness

$$\frac{{t}_{ads}^{2}}{{d}_{mp} * {D}_{k} ( {a}_{mp} , T )} = \frac{{r}_{c}^{2}}{600 {D}_{μ}}$$

to ensure vapor transport through the macro-pores will not be limited and the highest power for a given amount of adsorbent can be achieved under isothermal conditions.

The introduction of the BACT method will reduce material waste, fabrication time, and enhances the kinetics of the adsorption process to mimic that of straight walled channels-eliminating the tortuosity term through the foam thickness. With such fast kinetics enabled by high surface area and low mass transfer resistance, it was possible to create a coating with a SCP_{ads} of 1875 W/kg, a SCP_{v,tot} of 2.85e3 kW/m³, and an SCP_{m,tot} of 375 W/kg-all of which are the best of literature known to date. This represents a 2× improvement over the ID sample used to design the 1:10 scale prototype, which means that it could effectively cut the mass and volume of the device by ½ to achieve the same power requirements. The BACT method promises to deliver significant performance enhancements across adsorption devices by decoupling the saturation time from the coating thickness by introducing a new optimization parameter, the size of the straight walled channel pore, to enhance the surface area of exposed adsorbent to the boundary concentration and shift the inter-crystalline diffusive length scale from millimeters to μm. The ideal macro-pore size or adsorbent layer thickness, depending on whichever is fixed, can be computed based on setting Biₘ=0.1 to ensure that maximum power can be delivered at all times by utilizing the adsorbent coating through the foam thickness. The BACT method can be applied to other adsorption-based systems, such as carbon capture and atmospheric water harvesting. The coating process parameters and their impact on coating structure can impact the system level mass and volume impacts of tailoring the BACT method for adsorption systems.

The BACT method can be refined to explore the impact of characteristic pore sizes generated in this method, and build a model to try to control them through the process temperature, mixture loading and viscosity, particle size, and binding scaffold geometry. The BACT method can be used in multiple applications, from space cooling, catalysis, carbon capture, to atmospheric water harvesting. This last area is exemplified here.

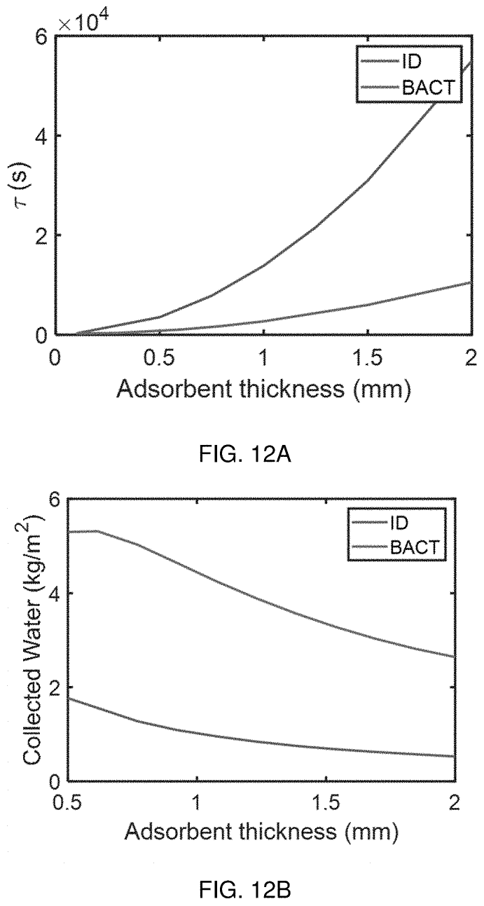

Atmospheric water harvesting is the process by which water can be pulled out of the air using adsorbents that can then be used for drinking or other applications requiring high quality water. It has the same thermodynamic cycle as the adsorption-based cooling, and uses many of the same materials. In both cases, it is essential to maximize the adsorption rate to increase cooling power or to maximize the water harvested per day. Using the same models and adjusting the diffusivities to account for the diffusivity of water in air, the potential water adsorbed per day can be compared, assuming a 10 minute desorption cycle using resistive heating or combustion to generate heat to desorb the material. The assumptions include that there is a fan blowing air over the device such that the boundary concentration is equal to the environmental conditions at all time, that also keeps the adsorbent isothermal. In this case, a material as simulated that has an uptake of 0.5 g/g uptake at 27° C. While the amount of water adsorbed is relative in FIGS. 12A-12B, the timescale analysis will hold for any uptake as it is a function of nondimensional uptake. This assumes an 80 μm pore with 30 μm coating thickness, a macro-porosity of 0.6 and local coating porosity of 0.3.

In FIGS. 12A-12B, the amount of time r it takes for a fully desorbed coating to adsorb

$$( 1 - \frac{1}{e} ) Δ w$$

was compared which in this case was an uptake of 0.316 g/g. The divergence in the characteristic adsorption time grows rapidly as the coating thickness grows due to the lack of exposed adsorbent to humid air and slow transport through the thickness of the coating. For the 2 mm sample, it takes the ID samples 5.2 times longer to adsorb the required amount as the BACT samples do. Shorter cycle times enable more cycles per day, generally resulting in more water produced per day, peaking at 5.3 kg/m²-day for the BACT sample with a 0.6 mm coating thickness. The ID samples are only able to produce 1.7 kg/m²-day for the same coating thickness due to its reduced surface area.

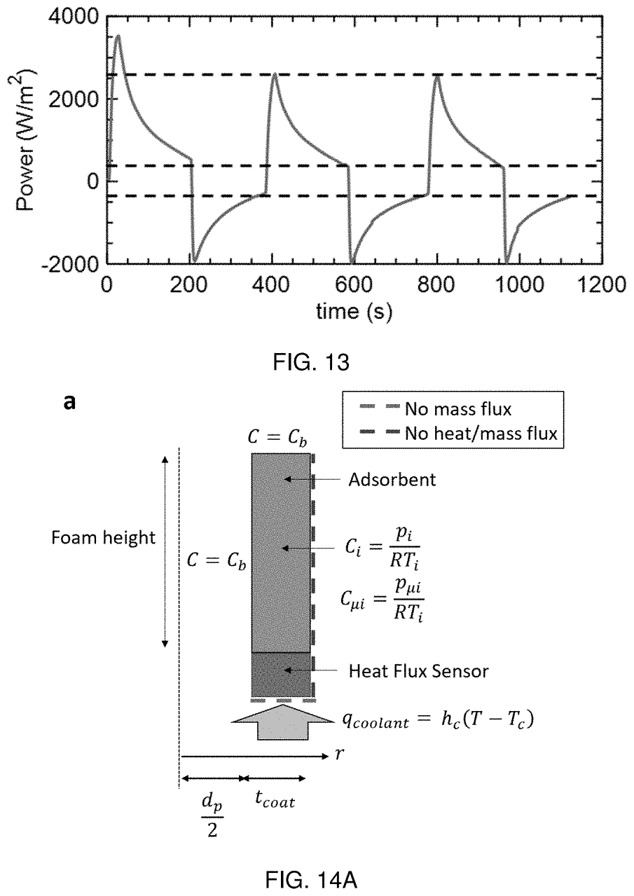

In the experiments described herein, cyclical stability tests were completed to validate the assumption that the ABU would reach steady state by its third cycle. This is confirmed by the experimental results shown in FIG. 13 for a 200 second adsorption and desorption time. The larger peak during adsorption compared to desorption can be accounted for by the larger entropy of adsorption compared to desorption (h_{ad}˜1.4*h_{fg}). While the first peak is significantly higher, this is also expected as the entropy of adsorption is significantly higher at low uptakes than for higher uptakes as stronger water-adsorbent interactions occur in the beginning of adsorption. The consistency of the second and third cycle peaks show that the adsorption and desorption have reached their steady state value and that the values to determine the resulting cooling power for steady state operation of 200 second cycles can be used.

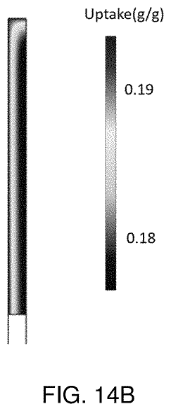

Straight channel pores can be modelled. To create an upper limit for practical adsorbent coating designs to compare the BACT samples against in this work, a straight channel pore model was created. This model was almost identical to the model used for the ABU optimization, except that only a single pore was modelled within the adsorbent coating. This channel was assumed to have a pore diameter of 80 μm, as was found to be the average diameter of the pores of the BACT method. Based on the macro-porosity measurements of the adsorbent coating, the local porosity of the coating on the copper foam was calculated to be 0.3. At this macro-pore size, the concentration at the boundary can be approximated as a constant. While the adsorbent coating layer now has very small intra-crystalline pore sizes that impede transport, it's the coating thickness t_{coat} is so small that the timescale to diffusive through the dense-thin coating is still on the order of 10 times faster than through a 1 mm coating. In FIGS. 14A-14B, a schematic of the straight channel pore model is shown, as well as the results at 75 seconds into a 120 second adsorption cycle to show the nearly uniform uptake through the coating to validate this assumption. The concentration at the boundary is derived from the partial pressure of vapor created by the evaporator at 5.5° C. As was discussed above, there is a coolant loop running underneath of the heat flux sensor to absorb the heat generated by the adsorbent. The right-hand side of the coating is assumed to have no heat or mass transfer assuming that there is another coating of equal thickness at the neighboring pore.

A predictive model can be built to capture the agglomeration physics in the three phase flow involved in this coating method to predict the coating thickness on the copper foam to aid in further testing and investigating the impact of the macro-pore diameter, layer height, and coating thickness on the device performance. The model can be tested against various samples made that vary operational conditions, such as the process temperature, heat flux, or operating pressure, as well as the solvent, adsorbent, mixture viscosity, and structural binder. A variation of this approach that involves introducing a gas stream, rather than boiling the solvent away, can introduce new operating regimes in terms of pressure and evaporation rate that could not be achieved with temperature alone. Further, the nanofabrication of these straight walled channels as a structure to apply the BACT method to, in addition to working with suppliers to tailor the pore size of metallic and other foam structures can be achieved. Finally, the BACT approach can be implemented in the fields of carbon capture, atmospheric water harvesting, catalytic reactions, adsorption-based desalination, and many other adsorption-based systems.

Adsorption systems need to balance many factors to be successful for a given objective, specifically the kinetics resulting from the adsorbent coating plays a major role in dictating the performance of an adsorption-based system. The introduction of the BACT coating method will not only reduce waste material and reduce fabrication time; it will ensure fast kinetics enabled by high surface area and low mass transfer resistance within the channel. The kinetics of adsorbent coating done using the BACT method will mimic those of straight channels reducing the tortuosity effect. The method can produce porous structures that with continuous one-dimensional vapor channels throughout the thickness of the porous medium. The channels are initiated on the surface of the heating source and extend vertically. This is a result of the boiling of the liquid and bubble formation at the surface of the heating source.

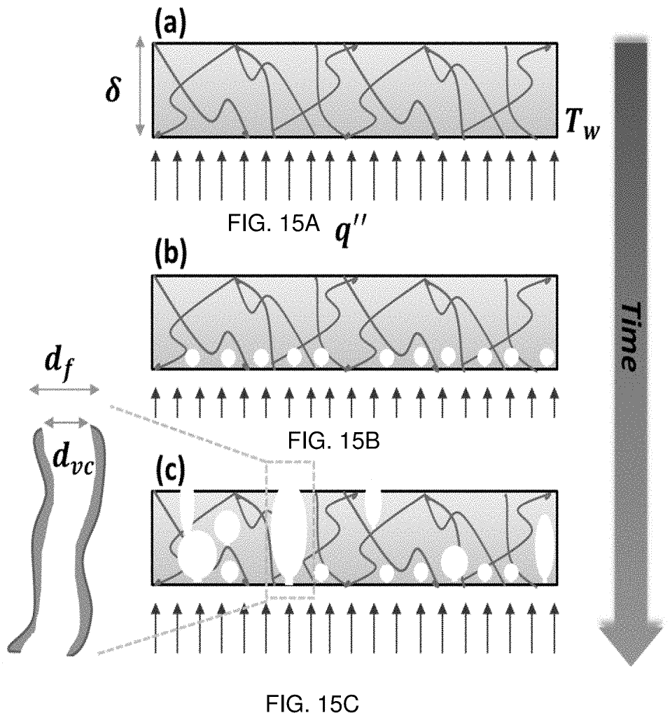

The physics of bubble dynamics can be characterized by pool boiling and vapor generation. The liquid mixture that wets the surface of the heating element. In pool boiling, bubble dynamics are characterized by the mechanisms of finite liquid replenishment and vapor generation. See, for example, Q. N. Pham et al., “Boiling Heat Transfer with a Well-Ordered Microporous Architecture,” ACS Appl. Mater. Interfaces, vol. 12, no. 16, pp. 19174-19183, April 2020, doi: 10.1021/acsami.0c01113, which is incorporated by reference in its entirety. FIGS. 15A-15C show a time-elapsed representation of the BACT coating method. As generated vapor expands and grows to escape from the porous media, the maximum viscous pressure loss that the vapor can experience can be estimated by Darcy's law:

$$\frac{\partial {p}_{v}}{\partial y} = - \frac{{μ}_{v} {U}_{ν}}{{κ}_{ν}}$$

where μᵥ is the vapor dynamic viscosity, Kᵥ is the vapor permeability through the porous medium, and Uᵥ is the vapor velocity. Integrating along the thickness of the porous medium with a thickness δ, results in:

$$Δ {p}_{v} = \frac{{μ}_{v} δ {U}_{v}}{{κ}_{v}}$$

As the vapor moves upward in the porous medium, the achieved vapor velocity can be determined as:

$${U}_{v} = \frac{{q}^{″}}{{ρ}_{v} {h}_{lv}}$$

where q″ is the heat flux of the heating source, ρᵥ, is the vapor density, and hᵢᵥ, latent heat of vaporization of liquid in porous medium. The vapor pressure can be estimated by the wall superheat using Clausius—Clapeyron equation:

$$Δ {p}_{v} = \frac{{h}_{lv} Δ T}{{T}_{s a t} Δ v} = \frac{{h}_{l v} Δ T}{{T}_{s a t}} ( \frac{{ρ}_{v} {ρ}_{l}}{{ρ}_{l} - {ρ}_{v}} )$$

The permeability, ,Kᵥ, is a measure of how easily fluid can flow through a porous material and can be estimated by:

$${κ}_{v} = \frac{φ {d}_{vc}^{2}}{32}$$

where φ is the porosity of the material and d_{vc} is vapor channel diameter. See, for example, B. M. Cummins, R. Chinthapatla, F. S. Ligler, and G. M. Walker, “Time-Dependent Model for Fluid Flow in Porous Materials with Multiple Pore Sizes,” Anal. Chem., vol. 89, no. 8, pp. 4377-4381, April 2017, doi: 10.1021/acs.analchem.6b04717, which is incorporated by reference in its entirety. From these insights, Darcy's law can be expressed as:

$$\frac{{h}_{lv} Δ T}{{T}_{s a t}} ( \frac{{ρ}_{v} {ρ}_{l}}{{ρ}_{l} - {ρ}_{v}} ) = \frac{32 {μ}_{v} δ}{φ {d}_{vc}^{2}} ( \frac{{q}^{″}}{{ρ}_{v} {h}_{lv}} )$$

The expression above suggests that vapor channels created due to the BACT coating are influenced by wall superheat, density and dynamic viscosity of adsorbent mixture, porosity and thickness of the porous medium, and the heat flux from the heating source.

$${d}_{vc}^{2} = \frac{32 {v}_{v} δ}{φ} ( \frac{{q}^{″}}{{h}_{lv}} ) ( \frac{{T}_{s a t}}{{h}_{lv} Δ T} ) ( \frac{{ρ}_{l} - {ρ}_{v}}{{ρ}_{v} {ρ}_{l}} )$$

To validate the developed model, several experiments were conducted. The experiments were conducted on 0.6 mm thick copper foam (120 PPI). The average pore diameter of the uncoated copper foam 190 μm. Prior to coating procedure, the copper foam was cleaned with DI water, followed by an ethanol rinse to make the foam hydrophilic, followed by another DI rinse. The copper foam was then finally cleaned in 2 M HCl to remove any present oxidation prior to deposition. The foam was then rinsed again with DI water, and immediately dried using compressed air to reduce any oxidation before deposition. It was found that removing any excess water was essential for consistent coating fabrication, as any retained water diluted the zeolite-water mixture used later for deposition, leading to higher than desired porosity and occasionally oxidation during the air-drying process Immediately after drying, the foam should enter the deposition process.

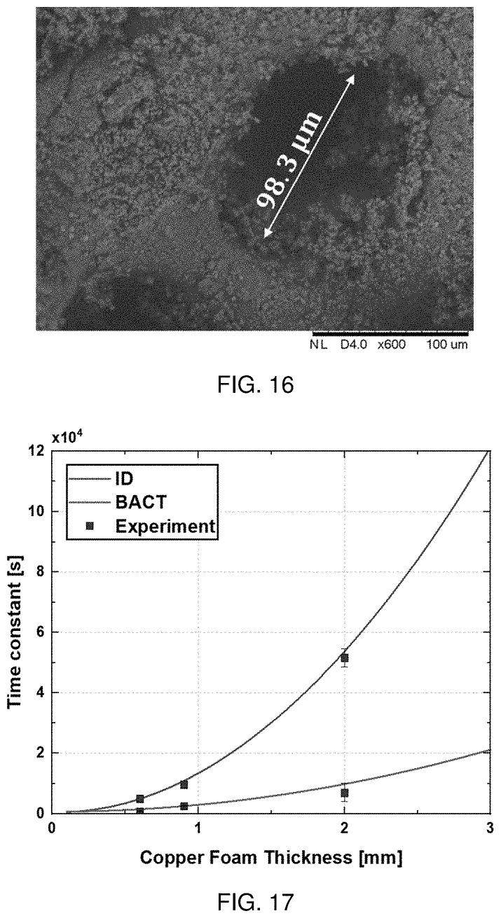

The coating a mixture of AQSOA Z02 and deionized (DI) water. Through experimentation, a mass ratio of zeolite:DI water of 1:1 was used to maintain a good dispersion of particles through the entire deposition process. First step of this deposition method is to dip the copper foam into the mixture for 1 minute to allow for full infiltration of the mixture into the pores. It is then placed on a hotplate at T_{w}=120° C. for 5 minutes. During this process, boiling is visible, and bubbles can be seen at the surface of the foam. The model predicted a vapor diameter of 91.64 μm which is in good agreement to what was seen in SEM image of the coated experiment. The diameter of the vapor channel is measured to be 98.3 μm. See FIG. 16.

The theoretical understanding of the BACT coating method helped in identifying what are the key parameters that can be tuned to achieve the desired coating thickness for a given application. To further see the benefit of the vapor channels created within the porous medium, the characteristic time scale to adsorb

$$( 1 - \frac{1}{e} ) Δ w$$

for traditional ID and BACT samples is in FIG. 17.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A method of fabricating an adsorption layer on a surface comprising:
infiltrating a mixture of an adsorbent material and a liquid into a porous structure; and
heating the liquid at a pressure and temperature to create bubbles at a surface of the porous structure, thereby evaporating the liquid to form a coating layer of adsorbent material on the surface of the porous structure.

2. The method of claim 1, wherein the coating layer includes one dimensional channels normal to a source of the heating.

3. The method of claim 1, wherein the pressure is atmospheric pressure.

4. The method of claim 1, wherein the liquid is water and the temperature is greater than 60° C. and less than 150° C.

5. The method of claim 1, wherein the liquid is water and the temperature is between 100° C. and 140° C.

6. The method of claim 1, wherein the heating is maintained for 60 minutes or less.

7. The method of claim 1, wherein the porous structure includes a majority of vapor channels continuous through a thickness of the porous structure.

8. The method of claim 1, wherein the adsorbent material comprises a zeolite, biporous zeolite, activated carbon, metal organic framework, silica gel, hygroscopic salt, hydrophilic polymer, or any combinations thereof.

9. The method of claim 1, wherein the adsorbent material comprises a zeolite.

10. The method of claim 1, wherein the porous structure is metallic or carbon-based foam.

11. The method of claim 1, wherein the porous structure is a copper foam.

12. The method of claim 1, wherein the porous structure has an average pore diameter of 50 microns to 250 microns.

13. A sorption bed comprising:
a porous structure including a coating layer of adsorbent material on the surface of the porous structure, wherein the porous structure includes a majority of vapor channels continuous through a thickness of the porous structure.

14. The sorption bed of claim 13, wherein the porous structure includes a majority of vapor channels continuous through a thickness of the porous structure.

15. The sorption bed of claim 13, wherein the adsorbent material comprises a zeolite, biporous zeolite, activated carbon, metal organic framework, silica gel, hygroscopic salt, or any combinations thereof.

16. The sorption bed of claim 13, wherein the adsorbent material on the surface of the porous structure is on a surface of the vapor channels.

17. The sorption bed of claim 13, wherein the adsorbent material comprises a zeolite.

18. The sorption bed of claim 13, wherein the porous structure is metallic or carbon-based foam.

19. An adsorption driven cooling system including a sorption bed of claim 13.

20. A capture device including a sorption bed of claim 13.
